(19) United States
(12) Patent Application Publication
(10) Pub. No.: US 2006/0092997 A1
(43) Pub. Date: May 4, 2006

(54) Laser beam generating apparatus for a laser scanning unit

(75) Inventor: Tae-kyoung Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/262,938

(22) Filed: Nov. 1, 2005

(30) Foreign Application Priority Data
Nov. 3, 2004 (KR) 10-2004-0088598

(51) Int. Cl. H01S 3/10

(52) U.S. Cl. 372/24

(57) ABSTRACT

A laser beam generating apparatus of a laser scanning unit, including: a laser diode; a collimate lens for converting a laser beam emitted from the laser diode to a parallel light; a collimate lens holder for disposing the collimate lens on an optical axis of the laser beam; a base for mounting the laser diode and the collimate lens holder thereon; and a supporting means formed on the base to provisionally fix the collimate lens holder. Since a dedicated implement complements an ultraviolet (UV) bond to provisionally fix the collimate lens holder in the calibration position, assembling errors can be prevented although the UV bond changes in volume while being hardened, thereby improving productivity and quality of goods.

### CROSS-REFERENCE TO RELATED APPLICATIONS

This application claims benefit under 35 U.S.C. § 119(a) of Korean Patent Application No. 2004-88598, filed Nov. 3, 2004, the entire contents of which are incorporated herein by reference.

### BACKGROUND OF THE INVENTION

1. Field of the Invention

The present invention relates to a laser beam generating apparatus for a laser scanning unit.

2. Description of the Related Art

Image forming apparatuses generally include a laser scanning unit for irradiating a laser beam on a photoconductive medium, thereby forming an electrostatic latent image. The laser scanning unit includes a laser beam generating apparatus for generating at least one laser beam of which a pattern is varied by image information.

FIGS. 1 and 2 illustrate an example of a conventional laser beam generating apparatus.

As shown in FIGS. 1 and 2, the laser beam generating apparatus includes a laser diode 10, a collimate lens holder 20 and a base 30.

The laser diode 10 is connected to a printing circuit board 11 to generate a laser beam.

The collimate lens holder 20 is disposed on an optical axis of the laser beam irradiated from the laser diode 10 and includes therein a collimate lens 21 for converting the laser beam into a parallel light. In addition, the collimate lens holder 20 includes a fixing piece 22 protrudingly formed to fix the position thereof.

The base 30 includes a mounting hole 31 for receiving the laser diode 10 and a holder mounting portion 32 for receiving the collimate lens holder 20. The holder mounting portion 32 has a slit 33 for insertion of the fixing piece 22.

In the above-structured laser beam generating apparatus, the collimate lens holder 20 is locationally adjusted and then fixed to a base which is a reference plate. In order to fix the collimate lens holder 20 adjusted to a calibration position, an ultraviolet (UV) bond 40 is filled into a gap between the holder mounting portion 32 and the collimate lens holder 20 and hardened, as shown in FIG. 2.

However, when the UV bond 40 is hardened by radiation of an ultraviolet ray after being applied in a liquid form, heat is generated, thereby causing change in volume of the applied UV bond. According to the conventional laser beam generating apparatus shown in FIG. 2, it is hard to prevent the volume change because the UV bond 40 is applied only under the collimate lens holder 20. As a result, in the process of adjusting the location of the collimate lens holder 20 with respect to an optical axis and a beam diameter and fixing the adjusted location using the UV bond 40, assembling errors may frequently occur due to the change in volume of the UV bond 40.

### SUMMARY OF THE INVENTION

Additional aspects and/or advantages of the invention will be set forth in part in the description which follows and, in part, will be apparent from the description, or may be learned by practice of the invention.

An aspect of the present invention is to solve at least the above problems and/or disadvantages and to provide at least the advantages described below. Accordingly, an aspect of the present invention is to provide a laser beam generating apparatus of a laser scanning unit, capable of restraining assembling errors which may be generated in the process of fixing an adjusted location of a collimate lens holder with respect to an optical axis and a beam diameter.

In order to achieve the above-described aspects of the present invention, there is provided a laser beam generating apparatus of a laser scanning unit, including a laser diode, a collimate lens for converting a laser beam emitted from the laser diode to a parallel light, a collimate lens holder for disposing the collimate lens on an optical axis of the laser beam, a base for mounting the laser diode and the collimate lens holder thereon, and a supporting means formed on the base to provisionally fix the collimate lens holder.

The base includes a first frame for mounting the laser diode; a second frame perpendicularly connected to the first frame to mount the collimate lens holder; and a fixing flange extended from the second frame.

The first frame has a through-hole for mounting the laser diode in the center thereof.

The second frame includes upper and lower frames for supporting a vertical movement of the collimate lens holder; and a side frame for supporting a flank side of the collimate lens holder. A distance between the upper and the lower frames corresponds to the greatest outer diameter of the collimate lens holder.

The supporting means includes a supporting rib protrudingly formed on the upper and the lower frames to contact with the collimate lens holder; a guide rail formed on the side frame to support the flank side of the collimate lens holder; a resilient lever formed on the upper frame to prevent escape of the collimate lens holder; and a guide protrusion formed on the lower frame. An ultraviolet (UV) bond is applied around the supporting rib to fix the collimate lens holder.

The collimate lens holder may be made of transparent material and may focus the collimate lens by rotating the same. For this, the collimate lens holder includes first and second tube parts resiliently biased by the resilient lever; and a third tube part formed between the first and the second tube parts to have a greater diameter than the first and the second tube parts.

The third tube part includes a sliding slope spirally formed on an outer circumference thereof and held by the guide protrusion. The third tube part may further include an inlet for infusion of the UV bond for fixing the collimate lens.

According to another aspect of the present invention, there is provided a laser beam generating apparatus of a laser scanning unit, including a laser diode, a collimate lens for converting a laser beam emitted from the laser diode to a parallel light, a collimate lens holder for disposing the collimate lens on an optical axis of the laser beam, a base for mounting the laser diode and the collimate lens holder thereon, a supporting means formed on the base to provisionally fix the collimate lens holder, and an adjusting means for controlling the location of the collimate lens holder.

The collimate lens holder may have the same structure as the previous embodiment.

The adjusting means includes a first adjusting screw for controlling a horizontal location of the collimate lens holder by pressing the first tube part; and a second adjusting screw for controlling a vertical location of the collimate lens holder by pressing the second tube part.

The first adjusting screw and the collimate lens holder move in perpendicular directions to each other, and the second adjusting screw moves in the same direction as the collimate lens holder.

The first adjusting screw has a taper end for pressing a flank side of the collimate lens holder.

According to embodiments of the present invention, since a dedicated implement which provisionally fixes the collimate lens holder in the calibration position is used together with the UV bond, assembling errors caused by change in volume of the UV bond can be prevented, thereby improving productivity and quality of goods.

Moreover, since the implement can be integrally formed through injection molding, increases in the number of parts and the manufacturing cost are not induced.

### BRIEF DESCRIPTION OF THE DRAWINGS

The above aspect and other features of the present invention will become more apparent by describing in detail exemplary embodiments thereof with reference to the attached drawing figures, of which;

FIG. 1 is a perspective view of a conventional laser beam generating apparatus of a laser scanning unit;

FIG. 2 is a front view of FIG. 1;

FIG. 3 is a front view of a laser beam generating apparatus of a laser scanning unit, according to an embodiment of the present invention;

FIG. 4 is a side view of FIG. 3;

FIG. 5 is an exploded view of FIG. 4;

FIG. 6 is a perspective view of a collimate lens holder in the laser beam generating apparatus of the laser scanning unit, according to an embodiment of the present invention;

FIG. 7 is a sectional view of FIG. 6;

FIG. 8 is a partial sectional view showing main parts of FIG. 4; and

FIG. 9 is a side view of the laser beam generating apparatus of the laser scanning unit, according to an embodiment of the present invention, with an ultraviolet (UV) bond applied.

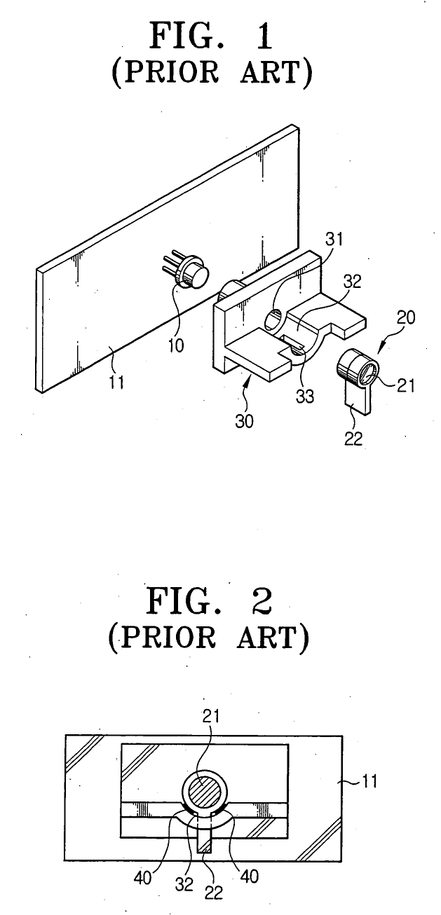

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

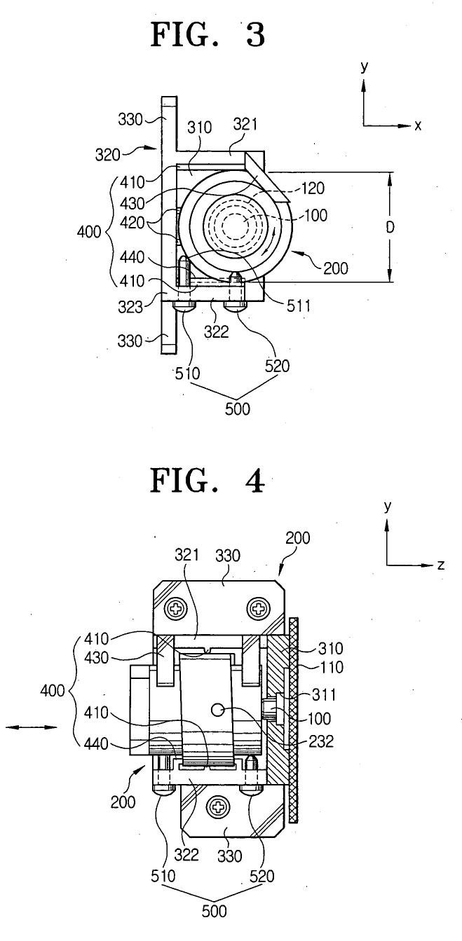

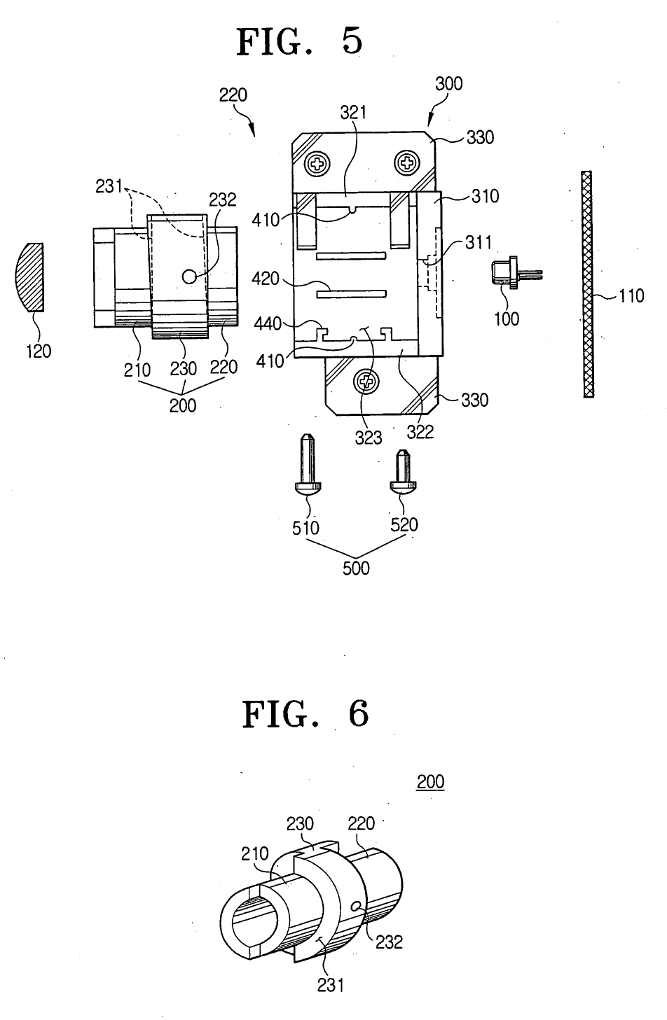

FIGS. 3 to 5 are a front view, a side view and an exploded view, respectively, of a laser beam generating apparatus according to an embodiment of the present invention.

The laser beam generating apparatus of a laser scanning unit, according to an embodiment of the present invention, includes a laser diode 100, a collimate lens 120, a collimate lens holder 200, a base 300 and a supporting means 400.

The laser diode 100 is connected to a printing circuit board 110 to irradiate a laser beam containing image information onto a photoconductive medium (not shown). The collimate lens 120 converts the laser beam emitted from the laser diode 100 into a parallel light.

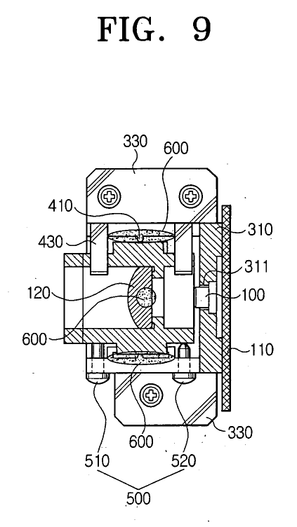

The collimate lens holder 200 disposes the collimate lens 120 on an optical axis of the laser beam, as shown in FIGS. 3 through 7. The collimate lens holder 200 rotates to focus the collimate lens 120 included therein. The collimate lens holder 200 is may be made of transparent material to enhance transmission of an ultraviolet (UV) ray for hardening a UV bond 600 (FIG. 9) applied to fix the collimate lens holder 200.

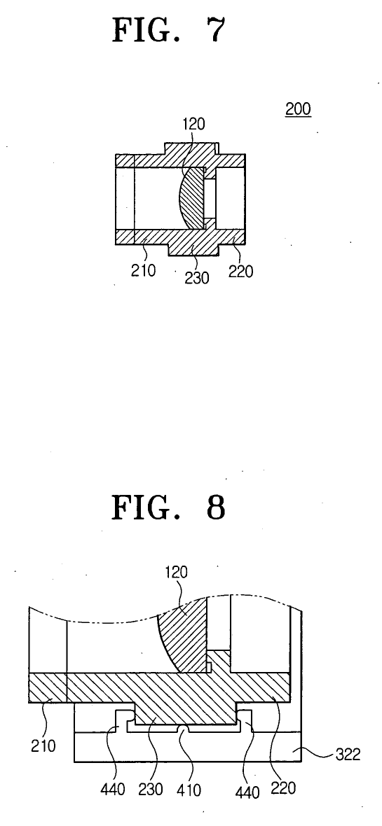

To this end, the collimate lens holder 200 may be formed as a stepwise cylinder including first to third tube parts 210, 220 and 230, as shown in FIG. 6. The third tube part 230 has the greatest diameter and includes a sliding slope 231 spirally winding once around an outer circumference thereof. As shown in FIGS. 6 and 7, the collimate lens holder 200 includes the collimate lens 120 and a UV bond inlet 232 for infusion of the UV bond that fixes the collimate lens 120.

On the base 300, the laser diode 100 and the collimate lens holder 200 are disposed on the optical axis of the laser beam.

The base 300 includes a first frame 310, a second frame 320 and a fixing flange 330.

The first frame 310 has a through-hole 311 for mounting the laser diode 100.

The second frame 320 is perpendicularly connected to the first frame 310 to mount the collimate lens holder 200. The second frame 320 may be formed as a square column having an opening, as shown in FIGS. 3 through 5.

The second frame 320 includes upper and lower frames 321 and 322 for supporting a vertical movement of the collimate lens holder 200, and a side frame 323 for supporting a flank side of the collimate lens holder 200. As shown in FIG. 3, a distance D between the upper and the lower frames 321 and 322 may correspond to the greatest outer diameter of the collimate lens holder 200, that is, an outer diameter of the third tube part 230.

The fixing flange 330 is formed by extending the second frame 320 to fix the base 300 on a predetermined position of the laser scanning unit.

The base 300 may be integrally formed with the first frame 310, the second frame 320 and the fixing flange 330 as a single assembly, of resilient material such as plastic by injection molding.

The supporting means 400 is formed on the base 300 to provisionally fix the collimate lens holder 200. The supporting means 400 includes a supporting rib 410, a guide rail 420, a resilient lever 430 and a guide protrusion 440.

The supporting rib 410 is protrudingly formed on inner surfaces of the upper and the lower frames 321 and 322, respectively, to contact to the collimate lens holder 200. As shown in FIG. 9, the UV bond 600 is applied around the supporting rib 410 to fix the collimate lens holder 200 when the location has been adjusted.

A pair of the guide rails 420 are formed on the side frame 323 to support the flank side of the collimate lens holder 200.

The resilient lever 430 is formed on the upper frame 321 to prevent escape of the collimate lens holder 200. A pair of the resilient members 430 may be extended from the upper frame 321 to bias the outer circumferences of the first and the second tube parts 210 and 220 by its own resilience.

The guide protrusion 440 is formed on the lower frame 322 to hold the sliding slope 231 provided on the third tube part 230, as shown in FIG. 8.

According to another embodiment of the present invention, the laser beam generating apparatus of a laser scanning unit may further include a plurality of adjusting means 500 for controlling a location of the collimate lens holder 200.

The adjusting means 500 includes a first adjusting screw 510 for pressing a bottom of the first tube part 210 and a second adjusting screw 520 for pressing a center portion of the second tube part 220.

The first adjusting screw 510 is tapered so that the tapered end presses a bottom of the collimate lens holder 200.

Hereinafter, processes for constructing the laser beam generating apparatus of a laser scanning unit will be described according to an embodiment of the present invention.

On the base 300, the laser diode 100 and the collimate lens holder 200 including the collimate lens 120 are disposed to correspond to the optical axis of the laser beam emitted from the laser diode 100.

As shown in FIGS. 3 and 4, the collimate lens holder 200 is mounted in a manner so that the first and the second tube parts 210 and 220 thereof are supported by the resilient lever 430. The third tube part 230 is supported by the supporting ribs 410 formed at the upper and the lower frames 321 and 322 and the guide rails 420 formed at the side frame 323.

The sliding slope 231 of the third tube part 230 is held by the guide protrusions 440 protruded from the lower frame 322. Therefore, by rotating the collimate lens holder 200 clockwise and counterclockwise as shown by the arrow in FIG. 3, the sliding slope 231 held by the guide protrusions 440 is relocated. Accordingly, the collimate lens holder 200 can be moved in the direction of the z-axis shown by the arrow in FIG. 4. Thus, the collimate lens 120 can be easily focused only by rotating the collimate lens holder 200 clockwise and counterclockwise.

Also, because the vertical movement of the collimate lens holder 200 is supported by the upper and the lower frames 321 and 322 and horizontal movement by the side frame 323 and the resilient lever 430, the collimate lens holder 200 can be provisionally fixed in the adjusted location. Therefore, as shown in FIG. 9, although the volume of the UV bond 600 changes while fixing the collimate lens holder 200, a calibration position of the collimate lens holder 200 can be maintained.

The laser beam generating apparatus according to another embodiment of the present invention may further include the adjusting means 500 at the lower frame 322. Since the other structures are the same as those of the previous embodiment, detailed description thereof will be omitted for conciseness.

The adjusting means 500 includes first and second adjusting screws 510 and 520 disposed to contact with the first and the second tube parts 210 and 220 so as to control the location of the collimate lens holder 200 in directions of x-axis and y-axis of FIG. 3.

The first adjusting screw 510 has a taper portion 511. The first adjusting screw 510 and the collimate lens holder 200 move perpendicularly to each other. More specifically, the first adjusting screw 510 is inserted so that the taper portion 511 is located at the flank side of the collimate lens holder 200 which is in contact with the first tube part 210 and the guide rail 420. Therefore, the taper portion 511 presses the first tube part 210 in the x-axis direction according to insertion and separation of the first adjusting screw 510, such that the collimate lens holder 200 can be minutely adjusted in the x-axis direction.

The second adjusting screw 520 is mounted to press the center portion of the second tube part 220. Therefore, by rotating the second adjusting screw 520 clockwise and counterclockwise, the second adjusting screw 520 and the collimate lens holder 200 can be moved in the same direction, that is, the y-axis direction of FIG. 3.

As described above, by providing the adjusting means 500, the location of the collimate lens holder 200 may be more minutely adjusted in directions of the x-axis and the y-axis.

In the laser beam generating apparatus according to embodiments of the present invention, since a dedicated implement complements the UV bond 600 to provisionally fix the collimate lens holder 200 adjusted to the calibration position, assembling errors do not occur although the UV bond 600 is changed in volume while being hardened, thereby improving productivity and quality of goods.

Moreover, since the dedicated implement can be integrally formed with the laser beam generating apparatus through injection molding, the number of parts and the manufacturing cost do not increase.

While the invention has been shown and described with reference to certain embodiments thereof, it will be understood by those skilled in the art that various changes in form and details may be made therein without departing from the spirit and scope of the invention as defined by the appended claims.

What is claimed is:

1. A laser beam generating apparatus of a laser scanning unit, comprising:
a laser diode;
a collimate lens for converting a laser beam emitted from the laser diode to a parallel light;
a collimate lens holder for disposing the collimate lens on an optical axis of the laser beam;
a base for mounting the laser diode and the collimate lens holder thereon; and
a supporting means formed on the base to provisionally fix the collimate lens holder.

2. The laser beam generating apparatus of claim 1, wherein the base comprises:
a first frame for mounting the laser diode;
a second frame perpendicularly connected to the first frame to mount the collimate lens holder; and
a fixing flange extended from the second frame.

3. The laser beam generating apparatus of claim 2, wherein the first frame has a through-hole for mounting the laser diode in the center thereof.

4. The laser beam generating apparatus of claim 2, wherein the second frame comprises:
upper and lower frames for supporting a vertical movement of the collimate lens holder; and
a side frame for supporting a flank side of the collimate lens holder.

5. The laser beam generating apparatus of claim 4, wherein a distance between the upper and the lower frames corresponds to the greatest outer diameter of the collimate lens holder.

6. The laser beam generating apparatus of claim 4, wherein the supporting means comprises:
a supporting rib protrudingly formed on the upper and the lower frames to contact with the collimate lens holder;
a guide rail formed on the side frame to support the flank side of the collimate lens holder;
a resilient lever formed on the upper frame to prevent escape of the collimate lens holder; and
a guide protrusion formed on the lower frame.

7. The laser beam generating apparatus of claim 6, wherein the collimate lens holder comprises:
first and second tube parts resiliently biased by the resilient lever; and
a third tube part formed between the first and the second tube parts to have a greater diameter than the first and the second tube parts.

8. The laser beam generating apparatus of claim 7, wherein the third tube part includes a sliding slope spirally formed on an outer circumference thereof and held by the guide protrusion.

9. The laser beam generating apparatus of claim 7, wherein the third tube part includes an ultraviolet (UV) bond inlet for infusion of the UV bond that fixes the collimate lens.

10. The laser beam generating apparatus of claim 6, wherein the UV bond is applied around the supporting rib to fix the collimate lens holder.

11. The laser beam generating apparatus of claim 1, wherein the collimate lens holder is made of transparent material.

12. The laser beam generating apparatus of claim 1, wherein the collimate lens holder focuses the collimate lens by rotating the same.

13. A laser beam generating apparatus of a laser scanning unit, comprising:
a laser diode;
a collimate lens for converting a laser beam emitted from the laser diode to a parallel light;
a collimate lens holder for disposing the collimate lens on an optical axis of the laser beam;
a base for mounting the laser diode and the collimate lens holder thereon;
a supporting means formed on the base to provisionally fix the collimate lens holder; and
an adjusting means for controlling a location of the collimate lens holder.

14. The laser beam generating apparatus of claim 13, wherein the collimate lens holder comprises:
first and second tube parts resiliently biased by the resilient lever; and
a third tube part formed between the first and the second tube parts to have a greater diameter than the first and the second tube parts.

15. The laser beam generating apparatus of claim 14, wherein the third tube part includes a sliding slope spirally formed on an outer circumference thereof and held by the guide protrusion.

16. The laser beam generating apparatus of claim 14, wherein the adjusting means comprises:
a first adjusting screw for controlling a horizontal location of the collimate lens holder by pressing the first tube part; and
a second adjusting screw for controlling a vertical location of the collimate lens holder by pressing the second tube part.

17. The laser beam generating apparatus of claim 14, wherein the first adjusting screw and the collimate lens holder move in perpendicular directions to each other, and the second adjusting screw moves in the same direction as the collimate lens holder.

18. The laser beam generating apparatus of claim 14, wherein the first adjusting screw has a taper end for pressing a flank side of the collimate lens holder.

19. The laser beam generating apparatus of claim 13, wherein the base comprises:
a first frame;
a second frame perpendicularly connected to the first frame; and
a fixing flange extended from the second frame.

20. The laser beam generating apparatus of claim 19, wherein the first frame, the second frame and the fixing flange are formed as a single assembly made of a resilient material.
